(19) United States
(12) Patent Application Publication
(10) Pub. No.: US 2025/0273448 A1
(43) Pub. Date: Aug. 28, 2025

(54) Systems and Methods for Determining Position and Time of Clipped ADC Ion Response Signals in Mass Spectrometry

(71) Applicant: DH Technologies Development Pte. Ltd., Singapore (SG)

(72) Inventor: Nicholas BLOOMFIELD, Newmarket (CA)

(73) Assignee: DH Technologies Development Pte. Ltd., Singapore (SG)

(21) Appl. No.: 18/859,312

(22) PCT Filed: Apr. 26, 2023
(86) PCT No.: PCT/IB2023/054303

§ 371 Date: Oct. 23, 2024

Related U.S. Application Data
(60) Provisional application No. 63/334,871, filed on Apr. 26, 2022.

(51) Int. Cl. H01J 49/00

(52) U.S. Cl. CPC H01J 49/0036

(57) ABSTRACT

A method for performing mass spectrometry comprises generating a plurality of ions from an analyte; directing the plurality of ions into an ion detector to generate a plurality of ion detection signals; generating a plurality of data points corresponding to the plurality of ion detection signals, each data point of the plurality of data points representing an intensity of detected ions as a function of an X-parameter, wherein the X-parameter is a function of a mass-to-charge ratio for the detected ions; identifying a cut off intensity corresponding to a set of cut off data points of the plurality of data points; identifying a set of selected data points of the plurality of data points based on the set of cut off data points; and deriving from the set of selected data points at least one characteristic corresponding to a maximum point associated with the plurality of data points.

### RELATED APPLICATIONS

This application claims priority to U.S. provisional application No. 63/334,871 filed on Apr. 26, 2022, entitled “Systems and Methods for Determining Position and Time of Clipped ADC Ion Response Signals in Mass Spectrometry” which is incorporated herein by reference in its entirety.

### TECHNICAL FIELD

The present disclosure relates generally to ion detectors and more specifically ion detectors used in mass spectrometry.

### BACKGROUND

Various technologies, such as mass spectrometers, generate different types of ions from some source molecules, e.g., analytes, create streams of those ions, and detect the ions by applying different techniques, such as the time-of-flight detection technique, to the streams. As part of the detection, the system may measure some physical properties of the ions and, from those physical properties, determine one or more properties of the source molecules, for example, their chemical composition, structure, etc., The measured physical properties of the ions may include their mass, charge, or the ratio of mass-to-charge (m/z) of each type of ion, or the intensity of the streams for each type of ion.

Existing technologies, however, may not be able to measure some of those physical properties accurately. For example, some of the available measurement instruments such as the analog-to-digital converter, ADC, may not be able to measure the intensity of the ion stream above some cut off limit. Therefore, new techniques are needed to remedy these shortcomings of the existing measuring instruments and to derive the physical properties of the ion streams more accurately from the inaccurate measurements of the available measuring instruments.

### SUMMARY

In some embodiments, the techniques described herein relate to a method for performing mass spectrometry, the method including: generating a plurality of ions from an analyte; directing the plurality of ions into an ion detector to generate a plurality of ion detection signals; generating a plurality of data points corresponding to the plurality of ion detection signals, each data point of the plurality of data points representing an intensity of detected ions as a function of an X-parameter, wherein the X-parameter is a function of a mass-to-charge ratio for the detected ions; identifying a cut off intensity corresponding to a set of cut off data points of the plurality of data points; identifying a set of selected data points of the plurality of data points based on the set of cut off data points; and deriving from the set of selected data points at least one characteristic corresponding to a maximum point associated with the plurality of data points.

In some embodiments, the techniques described herein relate to a method, wherein the set of cut off data points covers a cut-off section; and identifying the set of selected data points includes identifying a first selected data point having a first selected X-parameter located on a first side of the cut-off section and having a first selected intensity that is less than the cut off intensity; identifying a second selected data point having a second selected X-parameter located on a second side of the cut-off section and having a second selected intensity that is less than the cut off intensity and not less than the first selected intensity; and identifying a third selected data point having a third selected X-parameter located on the second side of the cut-off section and having a third selected intensity that is less than the first selected intensity.

In some embodiments, the techniques described herein relate to a method wherein deriving the at least one characteristic includes deriving from the second selected data point and the third selected data point an interpolation data point having an intensity equal to the first selected intensity and having an interpolation X-parameter that is not less than the second selected X-parameter and not greater than the third selected X-parameter; deriving a selected X-parameter width from a difference between the interpolation X-parameter and the first selected X-parameter; and deriving the at least one characteristic from the first selected intensity and the selected X-parameter width.

In some embodiments, the techniques described herein relate to a method, wherein deriving the at least one characteristic from the first selected intensity and the selected X-parameter width includes determining a ratio of the first selected intensity and the cut off intensity; and applying a conversion mechanism to the ratio and the selected X-parameter width to determine the at least one characteristic.

In some embodiments, the techniques described herein relate to a method, wherein the at least one characteristic includes an intensity of the maximum point associated with the plurality of data points.

In some embodiments, the techniques described herein relate to a method, wherein the at least one characteristic includes an X-parameter of the maximum point associated with the plurality of data points.

In some embodiments, the techniques described herein relate to a method, wherein the X-parameter is a time-of-flight of the detected ions.

In some embodiments, the techniques described herein relate to a mass spectrometer including: an ion-source configured to generate a plurality of ions from an analyte; an ion detector configured to receive the plurality of ions and to generate a plurality of ion detection signals; and an analyzer module configured to: generate a plurality of data points corresponding to the plurality of ion detection signals, each data point of the plurality of data points representing an intensity of detected ions as a function of an X-parameter, wherein the X-parameter corresponds to a mass-to-charge ratio of the detected ions; identify a cut off intensity corresponding to a set of cut off data points of the plurality of data points; identify a set of selected data points of the plurality of data points based on the set of cut off data points; and derive from the set of selected data points at least one characteristic corresponding to a maximum point associated with the plurality of data points.

In some embodiments, the techniques described herein relate to a mass spectrometer, wherein the set of cut off data points covers a cut-off section; and identifying the set of selected data points includes: identifying a first selected data point having a first selected X-parameter located on a first side of the cut-off section and having a first selected intensity that is less than the cut off intensity; identifying a second selected data point having a second selected X-parameter located on a second side of the cut-off section and having a second selected intensity that is less than the cut off intensity and not less than the first selected intensity; and identifying a third selected data point having a third selected X-parameter located on the second side of the cut-off section and having a third selected intensity that is less than the first selected intensity.

In some embodiments, the techniques described herein relate to a mass spectrometer wherein deriving the at least one characteristic includes: deriving from the second selected data point and the third selected data point an interpolation data point having an intensity equal to the first selected intensity and having an interpolation X-parameter that is not less than the second selected X-parameter and not greater than the third selected X-parameter; deriving a selected X-parameter width from a difference between the interpolation X-parameter and the first selected X-parameter; and deriving the at least one characteristic from the first selected intensity and the selected X-parameter width.

In some embodiments, the techniques described herein relate to a mass spectrometer, wherein deriving the at least one characteristic from the first selected intensity and the selected X-parameter width includes: determining a ratio of the first selected intensity and the cut off intensity; and applying a look up table to the ratio and the selected X-parameter width to determine the at least one characteristic.

In some embodiments, the techniques described herein relate to a mass spectrometer, wherein the at least one characteristic includes an intensity of the maximum point associated with the plurality of data points.

In some embodiments, the techniques described herein relate to a mass spectrometer, wherein the at least one characteristic includes an X-parameter of the maximum point associated with the plurality of data points.

In some embodiments, the techniques described herein relate to a method of performing mass spectrometry, the method including digitizing at least one analog ion detection signal to generate a digital signal including a plurality of data points, wherein the at least one analog ion detection signal is generated by an ion detector in response to detection of one or more ions received by the ion detector; identifying one or more cut-off data points corresponding to a cut-off intensity associated with the digital signal; selecting a plurality of selected data points from the plurality of data points, each selected data point of the plurality of selected data points representing a signal intensity that is lower than the cut-off intensity; utilizing the plurality of selected data points to determine a width of the digital signal; and utilizing the width of the digital signal to compute a true maximum intensity of the digital signal.

In some embodiments, the techniques described herein relate to a method, wherein the plurality of data points represent intensity of the digital signal as a function of time.

In some embodiments, the techniques described herein relate to a method, wherein the plurality of selected data points include: a first data point at a first temporal side of a cut-off section including the one or more cut-off data points; and at least two data points at a second temporal side of the cut-off section opposed to the first temporal side.

In some embodiments, the techniques described herein relate to a method, further including deriving an interpolation point corresponding to an intersection of an interpolation line connecting the at least two data points and a constant intensity line corresponding to an intensity of the first data point.

In some embodiments, the techniques described herein relate to a method, wherein the width of the digital signal is determined as a distance between the first data point and the interpolation point.

In some embodiments, the techniques described herein relate to a method, wherein digitizing the at least one analog ion detection signal includes feeding the at least one analog ion detection signal to an input of an analog-to-digital converter (ADC).

In some embodiments, the techniques described herein relate to a method, wherein the one or more cut-off data points correspond to portions of the analog signal exceeding a dynamic range of the ADC.

In some embodiments, the techniques described herein relate to a method, further including generating the one or more ions via ionization of at least one analyte in a sample. Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 is a block diagram of an ion detection system 100 according to some embodiments.

FIG. 2 shows a data graph 200, illustrating an example of signal truncation by the ADC according to some embodiments.

FIG. 3 is a flow chart of a maximum point derivation method 300 for deriving coordinates of the truncated maximum point corresponding to the truncated data according to some embodiments.

FIG. 4 illustrates an application of maximum point derivation method 300 to a set of data points according to an embodiment.

FIG. 5 shows a three dimensional look-up-surface 500 that depicts a look up table according to an embodiment.

FIG. 6 is a flow chart of a look up table generation method 600 according to some embodiments.

FIG. 7 shows a graph set 700 according to some embodiments.

FIG. 8 shows a look up table generator interface 800 according to some embodiments.

FIG. 9 schematically depicts an example of an implementation of a module 900 according to some embodiments.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be abbreviated. For brevity, well-known ideas or concepts may also not be discussed in an any great detail. One of ordinary skill will recognize that some embodiments of the present disclosure may not require certain aspects of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

Various embodiments address the deficiencies of available measurement instruments by providing techniques for deriving some physical properties of streams of ions from inaccurate measurements applied to the streams. These techniques may be implemented and added to some existing systems, as further detailed below.

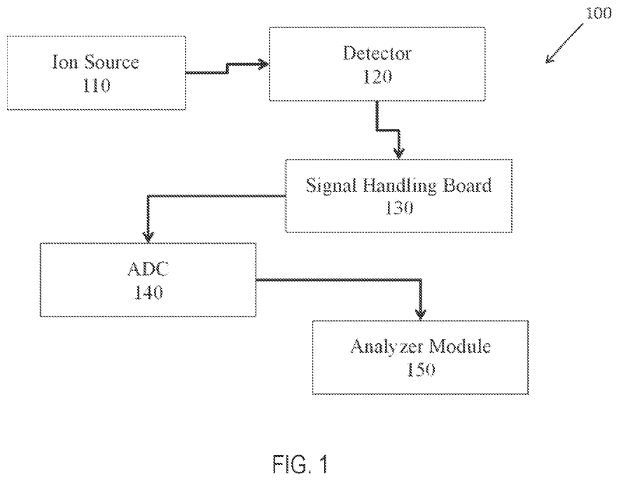

FIG. 1 is a block diagram of an ion detection system 100 according to some embodiments. Ion detection system 100 includes an ion source 110, a detector 120, a signal handling board 130, an ADC 140 (analog-to-digital converter), and an analyzer module 150.

In various embodiments, ion source 110 may generate one or more streams of ions and send them to detector 120. In some embodiments, ion source 110 may generate one or more pulses of ions, each called a push. For example, with each push, multiple ions of different types may leave ion source 110 and reach detector 120. The ions may reach detector 120 during a time period called time-of-flight (TOF) for that ion. The TOF for an ion may be a function of its mass-to-charge (m/z) ratio. Therefore, multiple ions of the same type may reach detector 120 simultaneously.

In some embodiments, the stream generated by each push may include multiple types of ions generated by ion source 110 and sent to detector 120. Moreover, each stream may include one or more of one type of ion. In particular, the relation among the number of ions of different types may reveal the composition or structure of one or more molecules from which the ions were generated.

Detector 120 may convert the detection of the ions received from ion source 110 into an output and send that output to signal handling board 130. In various embodiments, detector 120 may include a microchannel plate (MCP), which may generate one or more electrons for each ion that collides with the MCP. Further, in some embodiments, detector 120 may include a scintillator a photoelectric detector. The scintillator may generate one or more photons for each ion that collides with the scintillator, and the photoelectric detector may convert the photons into electric signals. In some embodiments, the output of detector 120 may be in the form of electrical signals and may have a maximum magnitude over 3 volts, depending on the number of detected ions. In some embodiments, for each push, the ions that have the same m/z and therefore reach detector 120 at approximately the same time, generate one signal, sometimes called a transient. Therefore, each push may generate multiple transients corresponding to multiple groups of ions generated in that push.

In some embodiments, signal handling board 130 may receive the signals sent by detector 120 and dampen the signals that are above 3 volts in order to protect ADC 140. In some embodiments, the signal thus handled by signal handling board 130 may have a maximum magnitude of around 4 volts. Signal handling board 130 sends the handled signal to ADC 140.

In some embodiments, ADC 140 may tolerate inputs of up to 10 volts, but may truncate (alternatively termed clip or cut off) signals that have a magnitude over a cut off value. In some embodiments, the cut off value may be, for example, around 250 mV (millivolts). The truncation of the signals is further described below. Some embodiments provide methods and systems for detecting the truncation of the signals and deriving the intensity and location of the non-truncated signal represented by the truncated signal, for accurate analysis of the data.

In some embodiments, ion detection system 100 is configured to receive multiple types of ions generated in multiple pushes and add up signals that correspond to ions that have the same m/z. In particular, in some embodiments, analyzer module 150 may receive the data corresponding to those added up signals and analyze the received data to determine the relative number of ions of different m/z values. In some embodiments, the relative intensity of the signal corresponding to each type of ion is proportional to or a function of the relative number of that type of ion detected by detector 120.

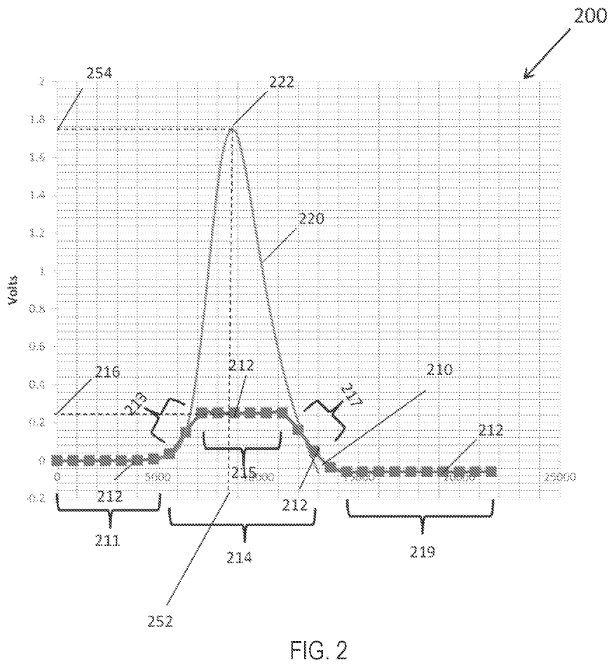

FIG. 2 shows a data graph 200, illustrating an example of data generated by the system for each transient and further illustrating signal truncation by the ADC according to some embodiments. In particular, in data graph 200, graph 220 corresponds to a non-truncated signal that would be generated for one transient. In data graph 200, the Y coordinate corresponds to the intensity of the signal measured by its electrical potential in volts and has a range between-0.2 volts and +2.0 volts. The X coordinate, on the other hand, corresponds to the time of detection of the signal, is measured in picoseconds (ps), and has a range of between zero and 25,000 picoseconds.

In various embodiments, the X and Y coordinates may correspond to various quantities that may indicate the number of ions detected as a function of their m/z. For example, the X coordinate may correspond to the time of arrival of the ions at the detector or the time of arrival of the signal at the ADC, etc. Moreover, the time may be measured with respect to the time that each push is performed. Generally, the X coordinates may measure a parameter hereinafter called an X-parameter. In various embodiments, the X-parameter may be a function of m/z of the detected ion. In some embodiments, for example, the X-parameter may correspond to the time-of-flight of the ion. In data graph 200, the signal shown by non-truncated graph 220 is peaked at an apex or maximum point 222 with an X value marked as common X-value 252 and having a value near 10,000 ps. This common X-value 252 corresponds to the m/z value of the ions in the transient corresponding to non-truncated graph 220.

The Y coordinate, on the other hand, may be a function of the number of ions present in the transient. For example, assuming that in this embodiment, each ion generates a 5 mV (millivolt) electrical signal and considering that the transient signal corresponding to non-truncated graph 220 has a magnitude of around 1750 mV (indicated by a maximum Y 254 corresponding to maximum point 222), the analyzer module may determine that this transient contained 350 (1750 mV divided by 5 mV) ions all with the same m/z corresponding to common X-value 252.

Upon receiving the signal, the ADC may sample and record the received signal at some discrete points of time. In data graph 200, the signal intensity is sampled at points of time that are separated by 800 ps, and each is displayed by a data point 212. As seen, the ADC truncates the intensities of the received signal at a cut off value 216 (around 250 mV) and, as a result, data points 212 together form a truncated graph 210. Truncated graph 210, or the set of data points 212, are themselves divided into five sections, left plateau section 211, left wing section 213, cut-off section 215, right wing section 217, and right plateau section 219. The combination of left wing section 213, cut-off section 215, and right wing section 217 forms a detected ions section or (more concisely) detection section 214.

Left and right plateau sections 211 and 219 include data points with zero intensity The rest of the data, that is, detection section 214, include data points 212 with non-zero signal intensity. Cut-off section 215, on the other hand, includes data points 212 for which the intensity is truncated at cut off value 216.

Some embodiments provide systems and methods that receive data corresponding to some detected ions and, based on the data, generate data points and accordingly derive characteristics of a non-truncated graph associated with the detected ions or, equivalently, with the data points. Examples of those systems and methods are further described below in detail.

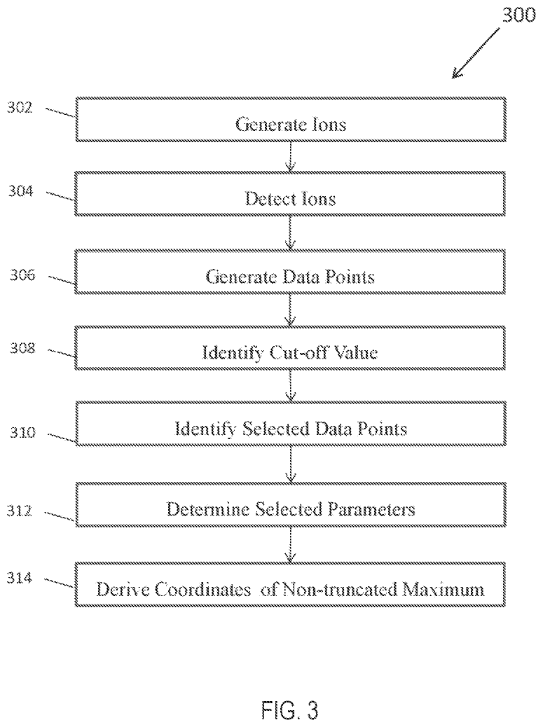

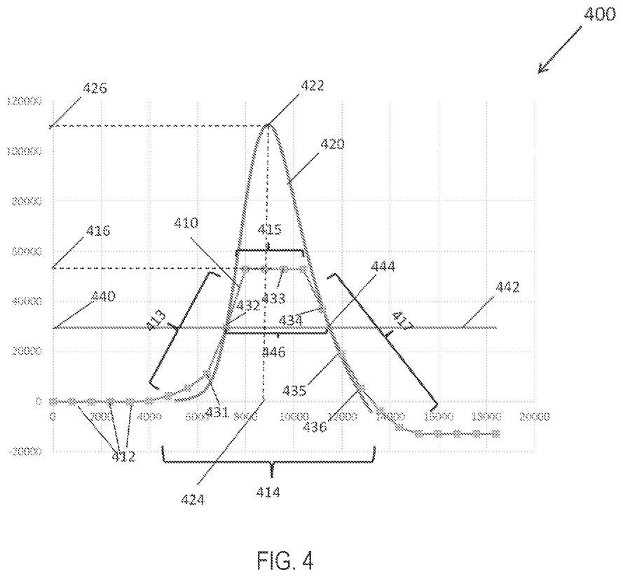

FIG. 3 is a flow chart of a maximum point derivation method 300 for deriving coordinates of the truncated maximum point corresponding to the truncated data according to some embodiments. Maximum point derivation method 300 may be performed by a system or parts of a system such as the ion detection system described above. Moreover, FIG. 4 illustrates an application of maximum point derivation method 300 to a set of data points according to an embodiment. More specifically, FIG. 4 shows a graph set 400 in which maximum point derivation method 300 has been applied for deriving a maximum Y and a common X-value for a common ion according to an embodiment.

Graph set 400 includes a truncated graph 410 that traces a set of data points such as data points 412 and 431-436, having sections such as a left wing section 413, a cut-off section 415, a right wing section 417, a combination of the three of which constitutes a detection section 414. Graph set 400 further includes a non-truncated graph 420, which includes non-truncated maximum point 422 having coordinates marked as a common X-value 424 and a maximum Y 426. Graph set 400 also includes a selected Y-value 440. These listed parts of graph set 400 are described below in detail.

Returning to method 300 of FIG. 3, at step 302 the system generates one or more ions. The ions may be generated by an ion source, such as a mass spectrometer or sections of a mass spectrometer.

At step 304, the system detects the one or more ions. The ions may be detected by any suitable detector, such as an electrical detector or an optical detector.

At step 306, the system may generate data points corresponding to the detected ions. The data points may, for example, correspond to the intensity and the time of the detection of signals corresponding to the detected ions.

Regarding step 306, graph set 400 includes multiple data points such as data points 431-436 generated by an ion detection system according to an embodiment. For each data point, the Y coordinate may be a function of the intensity of the corresponding signal and the X coordinate may be a function of the time of the detection of the corresponding signal. In graph set 400, the Y coordinate has a range between around −2000 to around 120,000 in ADC units, and the X coordinate has a range between 0 and 20,000 picoseconds. In some embodiments, the ADC, may record the Y coordinate in ADC units that correspond to 16 bit integers, therefore having a range of 2¹⁶=65536. In graph set 400, the data points in detection section 414, which have nonzero intensities, correspond to a transient that includes detected ions having a common m/z corresponding to common X-value 424 (around 9000 picoseconds).

Returning to method 300 of FIG. 3, at step 308 the system may identify a cut-off value. A cut-off value is a value on the Y axis at which the system or parts of the system, such as the ADC, has truncated the Y coordinate of the signals corresponding to one or more of the data points. In graph set 400, for example, the system may identify in truncated graph 410 a cut-off value 416, which is around 5500. The system may identify the cut-off value as the maximum value of the Y coordinate in the data points. In some embodiments, multiple consecutive data points, located at the cut-off section, may have the same Y coordinate equal to the cut-off value. In truncated graph 410, for example, the four data points in cut-off section 415, such as data point 433, display this property, indicating that their signal intensities have been truncated by the system. In some embodiments, ion detection system 100, or some parts of ion detection system 100 such as signal handling board 130 or ADC 140, may identify (flag) data points for which the intensity has been truncated.

Returning to method 300 of FIG. 3, at steps 310-316, the system uses the data points in truncated graph 410 to estimate some characteristics of non-truncated graph 420 and in particular the coordinates of non-truncated maximum point 422. To that end, at step 310, the system selects multiple data points in the manner described below and identifies them as selected data points to be used at subsequent steps.

More specifically, and referring to graph set 400 of FIG. 4, the system identifies three selected points 432, 434, and 435 in the following manner. First, the system identifies data points 432 and 434 as the data points that have the highest values of Y coordinates in left wing section 413 and right wing section 417 respectively. In other words, the system may select data points 432 and 434 as data points that have the highest values of Y coordinates on the two sides of cut-off section 415 and are not among the data points in cut-off section 415, indicating that their Y coordinates are not truncated. Next, the system compares the values of the Y coordinates of these two selected points and determines that data point 434 has a higher Y coordinate value. Then, the system identifies and selects data point 435 as the data point with the second highest Y coordinate value on the same wing section as data point 434, which is right wing section 417.

More generally, at step 310 the system may identify three selected data points that satisfy the following base conditions. To begin, a first one of them is located in one of the left or right wing sections, and the other two are located on the other wing section and their Y coordinates bracket (one is located above and one is located below) the Y coordinate of the first one. Additionally, at least the first two of the three selected data points need to have non-zero and non-truncated Y coordinates, so they cannot be in the plateau section or the cut-off section. In some embodiments, such as the one illustrated in graph set 400, in addition to the base conditions, the three selected data points also satisfy the additional condition that they are the highest such data points (that is, have the largest possible Y coordinates in this set) that satisfy the base conditions. But in other embodiments, they may not necessarily satisfy this additional condition. For example, using the data points in truncated graph 410, the system may instead select data point 435 on right wing section 417 as the first selected data point and select data points 432 and 431 respectively as the second and third selected data points on left wing section 413, noting that the Y coordinates of data points 432 and 431 bracket the Y coordinate of data point 435. Alternatively, and according to the same procedure, the system may select data point 431 as the first selected data point, and further select data points 435 and 436 as the second and third selected data points, respectively.

Returning to method 300 of FIG. 3, at step 312 the system uses the selected data points to determine one or more parameters called selected parameters. In some embodiments, the selected parameters include a selected Y-value (for example, selected intensity) and a selected width, as described below.

In some embodiments, to determine the selected parameters, first the system determines the Y coordinate of the first selected data point (here data point 432) as a selected Y-value (which, in graph set 400, is marked as a selected Y-value 440 and is around 30,000). Next, the system draws a cross section line 442 as a horizontal line with a Y coordinate equal to the selected Y-value. Next, the system determines an interpolation point 444 as the cross section of cross section line 442 and a straight line (interpolation line) that connects the second and third selected data points (here data points 434 and 435). Interpolation point 444, therefore, has a Y-value equal to the selected Y-value. Finally, the system determines a selected width as the distance between (or the difference in the X coordinates of) the first selected data point (here data point 432) and the interpolation point (here interpolation point 444). In graph set 400, the selected width is labeled as a selected width 446 and has a value around 4000 picoseconds.

Returning to method 300 of FIG. 3, at step 314, the system uses a conversion mechanism to derive the coordinates of the non-truncated maximum point from the selected parameters, such as the selected Y-value and the selected width determined in step 312. The conversion mechanism is further described below.

In some embodiments, the shape or the maximum point of non-truncated graph 420 may be uniquely determined from the selected parameters. The analyzer module may use one or more of the selected parameters as inputs into the conversion mechanism, in response to which the conversion mechanism may output the coordinates of the non-truncated maximum point. The conversion mechanism may include one or more of using an algorithm, a parametric formula for non-truncated graph 420, or a look up table. Examples of these methods are further described below. In the example of graph set 400, based on selected Y-value 440 and selected width 446 the system may derive the coordinates of the non-truncated maximum point 422, which are respectively labeled as a common X-value 424 and a maximum Y 426. In some embodiments, instead of using the absolute value of selected Y-value 440, the system may rescale selected Y-value 440 by cut-off value 416, and instead use this value of selected Y-value 440 divided by cut-off value 416 (called selected Y-rescaled) as the second parameter. Similarly, instead of deriving the absolute value of maximum Y 426, the system may derive a rescaled value for maximum Y 426, that is, the value of maximum Y 426 divided by cut-off value 416 (called maximum Y-rescaled).

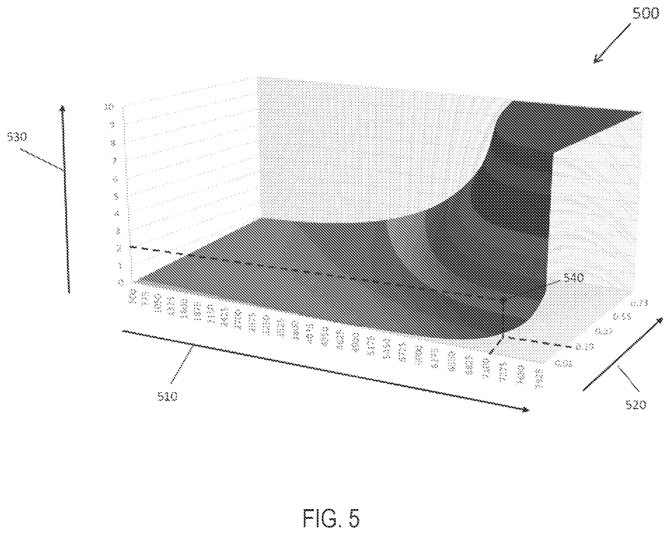

As mentioned above, in some embodiments, the system uses a conversion mechanism to derive from the selected parameters the coordinates of the non-truncated maximum point associated with the data points. Generally, the conversion mechanism may be a multivariable function that receives as inputs one or more of the selected parameters and outputs the coordinates of the non-truncated maximum point. In various embodiments, the conversion mechanism may be implemented in the form of a look up table, a two variable function or look up table illustrated via a three dimensional surface such as look-up-surface 500 discussed below in relation to FIG. 5, etc.

FIG. 5 shows a three dimensional look-up-surface 500 that depicts such a look up table according to an embodiment. More specifically, look-up-surface 500 is shown in a three dimensional space for which the three dimensions are marked as selected width 510, selected-intensity 520, and maximum-Y-rescaled 530. Equivalently, the look up table may receive values of selected width and selected Y-rescaled as two inputs and in return output the value of the maximum Y-rescaled, that is, the rescaled value of the Y coordinate for the non-truncated maximum point associated with those two inputs or the corresponding data points.

In order to use look up table (depicted by look-up-surface 500), the system may first use systems and methods discussed in relation to method 300 and graph set 400 to determine the selected width and the selected Y-rescaled from the data points corresponding to the detected ions. Next, the system may find a point on the look-up-surface 500 for which the coordinates along selected width 510 and selected-intensity 520 are respectively the determined selected width and selected Y-rescaled. The system may then determine the coordinate of the point along maximum-Y-rescaled 530 to be the maximum Y-rescaled for the rescaled Y of the non-truncated maximum point associated with the data points. In FIG. 5 this mechanism is illustrated by a point 540 on look-up-surface 500. In order to find point 540, the system has first determined, for the data points a selected width value of 7100 and a selected Y-rescaled value of 0.19, and marked them along selected width 510 and selected-intensity 520, respectively. Next, the system has found point 540 on look-up-surface 500 for which the projection on the plane of selected width 510 and selected-intensity 520 has these coordinates. Finally, the system has found the coordinate of point 540 along maximum-Y-rescaled 530 to have a value around 2.3, indicating that the non-truncated maximum point for the data points has a value around 2.3 times the cut off value for the data points. Equivalently, the system may input the determined values of 7100 and 0.19 in the look up table and receive and output of 2.3.

In the above mechanism, the system requires a look up table or its corresponding look up surface. Some embodiments utilize a look up table generation method to generate the look up table as further described below.

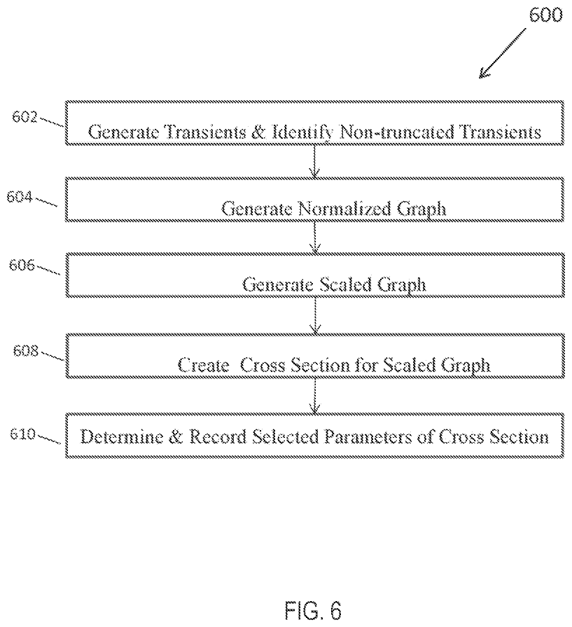

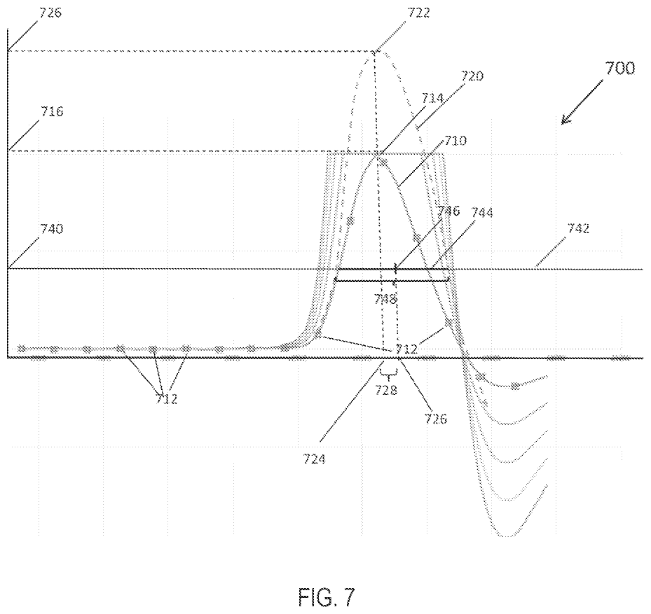

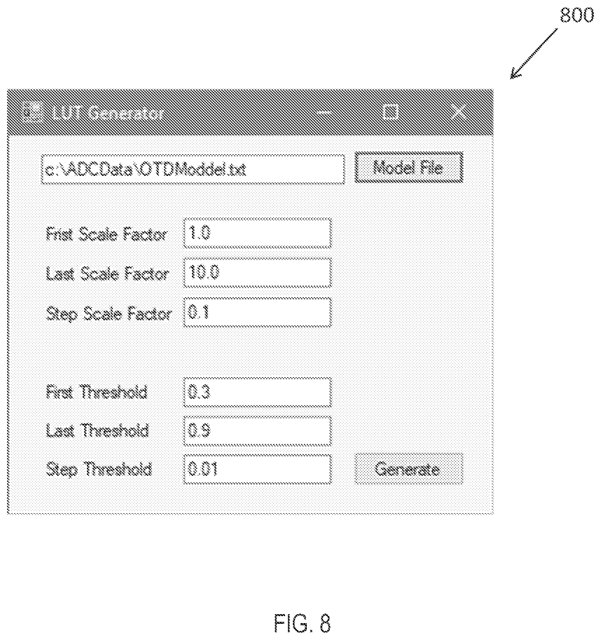

FIG. 6 is a flow chart of a look up table generation method 600 according to some embodiments. Method 600 may be performed by an ion detection system, or one or more of its parts such as the analyzer module. FIG. 7, on the other hand, shows a graph set 700 and FIG. 8 shows a look up table generator interface (abbreviated to LUTGI) 800, both utilized during implementation of method 600 according to some embodiments. FIGS. 6, 7, and 8 are further described below.

In method 600, at step 602, the system generates one or more transients, and among them identifies one or more transients that are not clipped or truncated. More specifically, the system may identify non-truncated ion detections as the ion detections that the ADC does not flag as truncated. In some embodiments, the system may estimate the number of ions in each transient and select those that include less than a set number of ions such that they are not truncated. In some embodiments, the number of ions in a transient may be estimated based on the maximum intensity of the transient. For example, in a system for which one ion generates a 10 mv signal, a transient with a maximum intensity of around 100 mv may be estimated to include around 10 ions. Moreover, assuming that the cutoff value in this system is around 250 mv, the system may identify as non-truncated transients for which the maximum intensity is below 250 mv and is instead below a set maximum value such as one of 250 mv, 200 mv, 150 mv, 100 mv, etc., or alternatively the estimated number of ions in the transient is below a maximum of 25 ion, or below a set number of ions that may be one of 20, 15, 10, etc. In graph set 700 of FIG. 7, data points 712 represent such data points generated for a non-truncated transient represented by graph 710.

Next, at step 604, the system generates a normalized graph, such as normalized graph 710. The normalized graph is a graph of a non-truncated transient for which the maximum point (such as apex 714) has a Y-coordinate equal to the cut-off value, such as cut-off value 716. To that end, the analyzer module may create a graph that connects the data points for each of the one or more of the non-truncated transients identified at step 602 and then rescale that graph such that its apex has a value equal to the cut-off value. Further, the analyzer module may aggregate such single transient normalized graphs to generate an aggregate normalized graph. For the aggregation, the analyze module may average the Y-coordinate values of the single transient normalized graphs for each X-coordinate. The aggregation, therefore, may result in a smoothed normalized graph to be used as the output of step 604.

The shape of the normalized graph may depend, for example, on the specifics of one or more of the different parts of the ion detection system, such as the ion source, the detector, the signal handling board, or the ADC. Therefore, the shape of the normalized graph may be specific to the ion detection system, but may not change for different rounds of detection using the same ion detection system. Therefore, the analyzer module may use the normalized graph to derive characteristics of transients generated by the same ion detection system, such as the characteristics of the apex (maximum point) of truncated transients as further described below. In some embodiments, the analyzer module may normalize the transient graphs such that the apex has a value other than the cut-off value. In some embodiments, this normalized value for the apex may be, for example, the intensity for transients corresponding to one ion. In various embodiments, for the normalized value for the apex, the analyzer module may choose any positive value that does not exceed the cut-off value. In some embodiments, the outcome of the analysis may not depend on this normalized value for the apex, as long as all graphs are normalized to the same apex value. In some embodiments the reason may be that the eventual analysis depends on the relative intensity of different ions and not their absolute values.

During the rest of method 600, the system generates, from normalized graph 710, multiple graphs, called scaled graphs, one of which is shown as scaled graph 720. For each scaled graph, a real number called a scale factor, is associated with the scaled graph. More specifically, each scaled graph is a scaled version of normalized graph 710 by a factor equal to its scale factor. That is, for each X coordinate, the Y coordinate of the scaled graph is equal to the scale factor times the Y coordinate of normalized graph 710 at the same X coordinate. Each scaled graph may represent a non-truncated graph representing signals associated with detection of multiple ions, where the signal intensity of the multiple ions is equal to the signal intensity for a single ion multiplied by the scale factor. Therefore, the system may derive, from the scaled graphs, the non-truncated parameters corresponding to truncated transients, such as the coordinates of the non-truncated maximum point corresponding to a truncated transient.

Returning to the specifics of method 600, at step 606, the system generates a scaled graph such as scaled graph 720. To that end, the system may select a scale factor (which, for scaled graph 720, is chosen to be 1.5) and, for each X coordinate, multiply the Y coordinate of normalized graph 710 by the selected scale factor to derive the Y coordinate of the corresponding scaled graph at the same X coordinate.

In FIG. 8, step 606 relates to the first three entries of LUTGI 800, which are labeled First Scale Factor, Last Scale Factor, and Step Scale Factor, and are respectively set to 1.0, 10.0, and 0.1. These settings indicate that, in this embodiment, the look up table generator will start the scale factor at a value equal to 1.0, and proceeds by incrementing the scale factor by 0.1 in each step, up to the maximum value of 10.0. For each value of the scale factor at each step, the look up table generator performs step 606, by generating the corresponding scaled graph as described above. Next, for the generated scaled graph, the system performs the remaining steps of method 600, as described below, to derive some entries of the look up table corresponding to the generated scaled graph.

Specifically, at step 608, the system creates a cross section of the generated scaled graph. To that end, the system selects a rescale value and creates a horizontal line, such as cross section line 742, for which the value of the Y coordinate rescaled by the cut off value (that is, the value of cut-off value 716) is equal to the selected rescale value. In the example of graph set 700, the selected rescale value for cross section line 742 (that is, the value of selected Y 740 divided by the value of cut-off value 716) is around 0.4.

Relating method 600 of FIG. 6 with LUTGI 800 of FIG. 8, step 608 in method 600 relates to the last three entries of LUTGI 800, which are labeled First Threshold, Last Threshold, and Step Threshold, and are respectively set to 0.3, 0.9, and 0.01. These settings indicated that, in this embodiment, for each generated scaled graph described earlier, the system will start the rescale value at 0.3, and proceeds by incrementing the rescale value by 0.01 in each step, up to the maximum rescale value of 0.9. For each pair of scale factor and rescale value, the system performs the remaining step of method 600, that is, step 610, to derive one entry of the look up table. Various embodiments may use other values for the settings.

More specifically, at step 610 of method 600, the system determines value of one or more parameters corresponding to the previously generated scaled graph and cross section, and records those parameters as one entry in the look up table. In particular, the parameters may include the selected Y-rescaled and the selected width. In the example illustrated in graph set 700, these parameters are depicted as a selected width 748 and selected Y 740 (to be divided by cut off value 716 to derive the selected Y-rescaled). In particular, selected width 748 is the length of a crossed section 744, which is the portion of cross section line 742 located inside scaled graph 720. The system may record these two values along with the coordinates of non-truncated maximum point 722 of scaled graph 720 as one entry in the look up table. The coordinates of non-truncated maximum point 722 may include its X-coordinate, that is, common X-value 724; and its Y coordinate, that is, maximum Y 726 (after being divided by cut-off value 716 to derive its rescaled value).

In some embodiments, instead of recording common X-value 724, the system may instead record a center shift 728. Center shift 728 may indicate the distance between common X-value 724 and the X-coordinate of a crossed section center 746, which is the midpoint of crossed section 744. The center shift may have an algebraic value, that is, it can be negative, zero, or a positive. For example, in some embodiments, the center shift is equal to the value of the X-coordinate of the crossed section center minus the common X-value. In such embodiments, when applying the conversion mechanism, in addition to determining the width, the system also finds the cross section and its midpoint, that is, the crossed section center and, from that, subtracts the center shift to derive the common X-value.

In some embodiments, one or more of the coordinates of the non-truncated maximum point may be a function of one, and not both, of the two parameters, and may not change with the other. For example, in some embodiments, on the common X-value or equivalently the center shift may not change with the selected Y (or equivalently the selected Y-rescaled) and only depend on the selected width. In such cases, the look up surface may be replaced with a look up curve that, for example, shows the value of the center shift as a function of the selected width.

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud,” to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory.

Further, in various embodiments, one or more of the storage media may be non-transitory computer-readable media that store data or computer programs executed by various modules, or implement various techniques or flow charts disclosed herein.

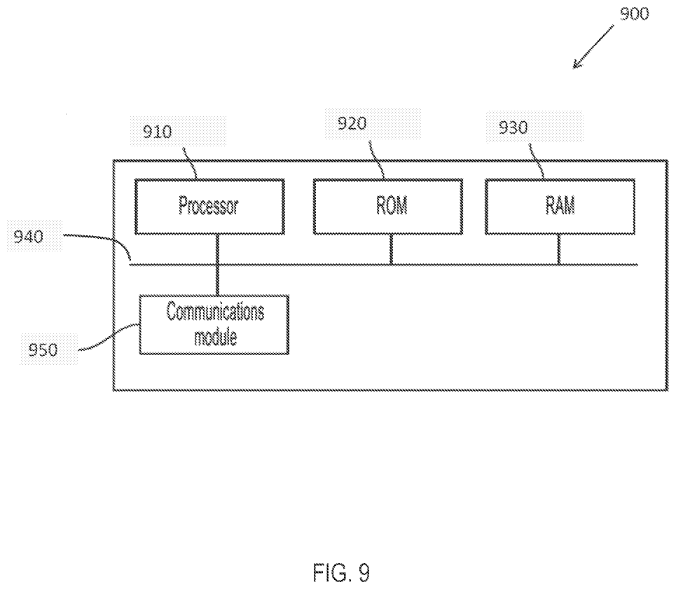

By way of example, FIG. 9 schematically depicts an example of an implementation of a module 900 according to some embodiments. Module 900 includes a processor 910 (e.g., a microprocessor), at least one permanent memory module (e.g., ROM 920), at least one transient memory module (e.g., RAM) 930, a bus 940, and a communication module 950.

Processor 910, ROM 920, and RAM 930 may be utilized to store and execute instructions performing the function of module 900. Moreover, bus 940 may allow communication between the processor and various other components of the controller. Communication module 950 may be configured to allow sending and receiving signals.

Although some aspects have been described in the context of a system and/or an apparatus, it is clear that these aspects may also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer, or an electronic circuit. In some embodiments, some one or more of the most important method steps may be executed by such an apparatus.

Those having ordinary skill will appreciate that various changes may be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A method for performing mass spectrometry, the method comprising:
generating a plurality of ions from an analyte;
directing the plurality of ions into an ion detector to generate a plurality of ion detection signals;
generating a plurality of data points corresponding to the plurality of ion detection signals, each data point of the plurality of data points representing an intensity of detected ions as a function of an X-parameter, wherein the X-parameter is a function of a mass-to-charge ratio for the detected ions;
identifying a cut off intensity corresponding to a set of cut off data points of the plurality of data points;
identifying a set of selected data points of the plurality of data points based on the set of cut off data points; and
deriving from the set of selected data points at least one characteristic corresponding to a maximum point associated with the plurality of data points.

2. The method of claim 1, wherein:
the set of cut off data points covers a cut-off section; and
identifying the set of selected data points comprises:
identifying a first selected data point having a first selected X-parameter located on a first side of the cut-off section and having a first selected intensity that is less than the cut off intensity;
identifying a second selected data point having a second selected X-parameter located on a second side of the cut-off section and having a second selected intensity that is less than the cut off intensity and not less than the first selected intensity; and
identifying a third selected data point having a third selected X-parameter located on the second side of the cut-off section and having a third selected intensity that is less than the first selected intensity.

3. The method of claim 2, wherein deriving the at least one characteristic comprises:
deriving from the second selected data point and the third selected data point an interpolation data point having an intensity equal to the first selected intensity and having an interpolation X-parameter that is not less than the second selected X-parameter and not greater than the third selected X-parameter;
deriving a selected X-parameter width from a difference between the interpolation X-parameter and the first selected X-parameter; and
deriving the at least one characteristic from the first selected intensity and the selected X-parameter width.

4. The method of claim 3, wherein deriving the at least one characteristic from the first selected intensity and the selected X-parameter width comprises:
determining a ratio of the first selected intensity and the cut off intensity; and
applying a conversion mechanism to the ratio and the selected X-parameter width to determine the at least one characteristic.

5. The method of claim 1, wherein the at least one characteristic includes an intensity of the maximum point associated with the plurality of data points.

6. The method of claim 1, wherein the at least one characteristic includes an X-parameter of the maximum point associated with the plurality of data points.

7. The method of claim 1, wherein the X-parameter is a time-of-flight of the detected ions.

8. A mass spectrometer comprising:
an ion-source configured to generate a plurality of ions from an analyte;
an ion detector configured to receive the plurality of ions and to generate a plurality of ion detection signals; and
an analyzer module configured to:
generate a plurality of data points corresponding to the plurality of ion detection signals, each data point of the plurality of data points representing an intensity of detected ions as a function of an X-parameter, wherein the X-parameter corresponds to a mass-to-charge ratio of the detected ions;
identify a cut off intensity corresponding to a set of cut off data points of the plurality of data points;
identify a set of selected data points of the plurality of data points based on the set of cut off data points; and
derive from the set of selected data points at least one characteristic corresponding to a maximum point associated with the plurality of data points.

9. The mass spectrometer of claim 8, wherein:
the set of cut off data points covers a cut-off section; and
identifying the set of selected data points comprises:
identifying a first selected data point having a first selected X-parameter located on a first side of the cut-off section and having a first selected intensity that is less than the cut off intensity;
identifying a second selected data point having a second selected X-parameter located on a second side of the cut-off section and having a second selected intensity that is less than the cut off intensity and not less than the first selected intensity; and
identifying a third selected data point having a third selected X-parameter located on the second side of the cut-off section and having a third selected intensity that is less than the first selected intensity.

10. The mass spectrometer of claim 9, wherein deriving the at least one characteristic comprises:
deriving from the second selected data point and the third selected data point an interpolation data point having an intensity equal to the first selected intensity and having an interpolation X-parameter that is not less than the second selected X-parameter and not greater than the third selected X-parameter;
deriving a selected X-parameter width from a difference between the interpolation X-parameter and the first selected X-parameter; and
deriving the at least one characteristic from the first selected intensity and the selected X-parameter width.

11. The mass spectrometer of claim 10, wherein deriving the at least one characteristic from the first selected intensity and the selected X-parameter width comprises:
determining a ratio of the first selected intensity and the cut off intensity; and
applying a look up table to the ratio and the selected X-parameter width to determine the at least one characteristic.

12. The mass spectrometer of claim 8, wherein the at least one characteristic includes an intensity of the maximum point associated with the plurality of data points, or
wherein the at least one characteristic includes an X-parameter of the maximum point associated with the plurality of data points.

13. (canceled)

14. A method of performing mass spectrometry, the method comprising:
digitizing at least one analog ion detection signal to generate a digital signal comprising a plurality of data points, wherein the at least one analog ion detection signal is generated by an ion detector in response to detection of one or more ions received by the ion detector;
identifying one or more cut-off data points corresponding to a cut-off intensity associated with the digital signal;
selecting a plurality of selected data points from the plurality of data points, each selected data point of the plurality of selected data points representing a signal intensity that is lower than the cut-off intensity;
utilizing the plurality of selected data points to determine a width of the digital signal; and
utilizing the width of the digital signal to compute a true maximum intensity of the digital signal.

15. The method of claim 14, wherein the plurality of data points represent intensity of the digital signal as a function of time.

16. The method of claim 15, wherein the plurality of selected data points comprise:
a first data point at a first temporal side of a cut-off section comprising the one or more cut-off data points; and
at least two data points at a second temporal side of the cut-off section opposed to the first temporal side.

17. The method of claim 16, further comprising deriving an interpolation point corresponding to an intersection of an interpolation line connecting the at least two data points and a constant intensity line corresponding to an intensity of the first data point.

18. The method of claim 17, wherein the width of the digital signal is determined as a distance between the first data point and the interpolation point.

19. The method of claim 14, wherein digitizing the at least one analog ion detection signal comprises feeding the at least one analog ion detection signal to an input of an analog-to-digital converter (ADC).

20. The method of claim 19, wherein the one or more cut-off data points correspond to portions of the analog signal exceeding a dynamic range of the ADC.

21. The method of claim 14, further comprising generating the one or more ions via ionization of at least one analyte in a sample.
